(19) United States
(12) Patent Application Publication
(10) Pub. No.: US 2007/0129207 A1
(43) Pub. Date: Jun. 7, 2007

(54) Method for mounting detection mechanism of planetary gear apparatus

(75) Inventor: Sadaharu Kanamori, Azumino-shi (JP)

Correspondence Address: BUCHANAN, INGERSOLL & ROONEY PC, POST OFFICE BOX 1404, ALEXANDRIA, VA, 22313-1404, US

(73) Assignee: HARMONIC DRIVE SYSTEMS INC., Tokyo (JP)

(21) Appl. No.: 11/581,475

(22) Filed: Oct. 17, 2006

(30) Foreign Application Priority Data
Dec. 7, 2005 (JP) 2005-353471

(51) Int. Cl. F16H 57/08

(52) U.S. Cl. 475/331

(57) ABSTRACT

A rotation actuator comprises a motor and a planetary reduction gear device, and an internal gear of the planetary reduction gear device has an internal gear formation portion in which internal teeth are formed, a thin cylindrical portion, and an annular flange fixed to a device housing. An external peripheral surface portion of the cylindrical portion is used as a location for attaching a strain gauge, and a space on the inner side of the cylindrical portion is used as a location for mounting an angle detector for an input shaft. By concentrically arranging the strain gauge and angle detector, a rotation actuator that has a short axial length and is provided with the two types of detection mechanisms can be achieved.

### BACKGROUND OF THE INVENTION

1. Field of the Invention

The present invention relates to a planetary gear apparatus having a load torque detection mechanism provided with a strain gauge or the like, and also having an encoder, resolver, or another rotational information detection mechanism, and more particularly relates to a detection mechanism mounting method for mounting the detection mechanisms without leading to an increase in the dimensions in the axial direction of the gear.

2. Description of the Related Art

Rotation actuators are known that have a configuration in which a planetary gear apparatus is coaxially connected and fixed to a motor output shaft. In such rotation actuators, an encoder, resolver, or another angle detector is mounted on the motor output shaft, on the input component of the planetary gear apparatus, or on the output component of the planetary gear apparatus in order to detect the rotational position of the rotation actuator. Also, a location in which strain is generated by load torque is formed in the transmission pathway of the rotational force in order to detect the load torque, and the strain generated in the location is detected using a strain gauge or the like to measure the load torque.

The angle detectors and torque sensors are mounted on the motor output shaft, on the input shaft or output shaft of the planetary gear apparatus, or on another component. Therefore, the dimension in the axial direction of the rotation actuator must be increased in order to secure a mounting location for these components.

### SUMMARY OF THE INVENTION

In view of the above, an object of the present invention is to provide a method for mounting a detection mechanism that can reduce the mounting space of a torque detection mechanism and a rotational information detection mechanism, and limit an increase in the axial length of a planetary gear apparatus.

Another object of the present invention is to provide a planetary gear apparatus that has a short axial length and is provided with a torque detection mechanism and a rotational information detection mechanism.

A further object of the present invention is to provide a rotation actuator comprising a planetary gear apparatus that has a short axial length and is provided with a torque detection mechanism and a rotational information detection mechanism.

Aimed at attaining the stated objects, the present invention provides a method for mounting a detection mechanism for a planetary gear apparatus, comprising:

forming a cylindrical portion between an internal gear formation portion and portions fixed to other members in an internal gear of a planetary gear apparatus;

using an external peripheral surface or internal peripheral surface of the cylindrical portion as a location for disposing or forming a detection element for detecting strain produced by load torque; and

using an inner portion of the cylindrical portion as a mounting location of a rotational information detection mechanism for detecting rotational information of an input rotation element or output rotation element of the planetary gear apparatus.

In the present invention, a thin cylindrical portion is formed between a fixed point and a force point in the internal gear, and a strain gauge for detecting mechanical strain is attached to the surface of the cylindrical portion. Therefore, a separate member does not need to be disposed in order to detect load torque, and a strain gauge or another detection element of a torque detection mechanism can be disposed or formed without significantly increasing the axial length. Also, since the internal space of the cylindrical portion is used as space for incorporating a rotational information detection mechanism such as an angle detector, the two detection mechanisms are thereby disposed in the radial direction, and an increase in the axial length is limited. Accordingly, a planetary gear apparatus that has a short axial length and is provided with a torque detection mechanism and a rotational information detection mechanism can be obtained.

In this case, in place of the cylindrical portion, a cylindrical portion and an annular portion that widens from one end of the cylindrical portion to the external side in the radial direction may be formed; an annular lateral surface of the annular portion may be used as a location for disposing or forming a detection element for detecting strain produced by load torque; and an inner portion of the cylindrical portion may be used as a mounting location of a detection mechanism for detecting rotational information of an input rotation element or output rotation element of the planetary gear apparatus.

Next, the present invention provides a planetary gear apparatus comprising a load torque detection device and a rotational information detection mechanism for detecting input rotational information or output rotational information, wherein the internal gear of the planetary gear apparatus has a cylindrical portion formed between an internal gear formation portion and portions fixed to other members; a detection element of the load torque detection mechanism is disposed or formed on an external peripheral surface or internal peripheral surface of the cylindrical portion; and the rotational information detection mechanism is disposed inside the cylindrical portion.

The present invention also provides a planetary gear apparatus comprising a load torque detection device and a rotational information detection mechanism for detecting input rotational information or output rotational information, wherein a cylindrical portion and an annular portion that widens from one end of the cylindrical portion to the external side in the radial direction are formed between an internal gear formation portion and portions fixed to other members in an internal gear of a planetary gear apparatus; a detection element of the load torque detection mechanism is disposed or formed on an annular lateral surface of the annular portion; and the rotational information detection mechanism is disposed inside the cylindrical portion.

Next, the present invention provides a rotation actuator comprising a motor, a planetary gear apparatus coaxially mounted on the motor, a rotation information detection mechanism for detecting rotational information of the output shaft of the motor, and a torque detection mechanism for detecting a load torque of the planetary gear apparatus,

wherein the planetary gear apparatus comprises a cylindrical device housing, an internal gear fixed to the device housing, an input shaft coaxially connected to the output shaft of the motor, a sun gear formed on the input shaft, and at least one planetary gear that meshes with the internal gear and the sun gear,

wherein the internal gear has an internal gear formation portion in which internal teeth that mesh with the planetary gear are formed, a cylindrical portion that coaxially extends from one end of the internal tooth formation portion, and an annular flange connected to the edge of the cylindrical portion; the annular flange being fixed to the device housing; and

wherein a detection element of the load torque detection mechanism is disposed or formed on an external peripheral surface or internal peripheral surface of the cylindrical portion; and the rotational information detection mechanism mounted on the input shaft is mounted on the inner side of the cylindrical portion.

In the present invention, a cylindrical portion for disposing or forming a strain gauge or another detection element for detecting strain produced by load torque is formed on the internal gear of a planetary gear apparatus, and the inner space of the cylindrical portion is used as a location for mounting an encoder, resolver, or another rotational information detector. Therefore, in accordance with the present invention, two types of detection mechanisms can be incorporated into a planetary gear apparatus without a considerable increase in the axial length. Also, two types of detection mechanisms can be incorporated into a rotation actuator having a motor and a planetary gear apparatus without a considerable increase in the axial length.

### BRIEF DESCRIPTION OF THE DRAWINGS

FIG. 1 is a schematic longitudinal sectional view of a rotation actuator in which the present invention has been applied; and

FIGS. 2A and 2B are schematic views showing another examples of an internal gear of a planetary reduction gear device.

### DESCRIPTION OF THE PREFERRED EMBODIMENTS

An embodiment of a rotation actuator to which the present invention has been applied is described below with reference to the diagrams.

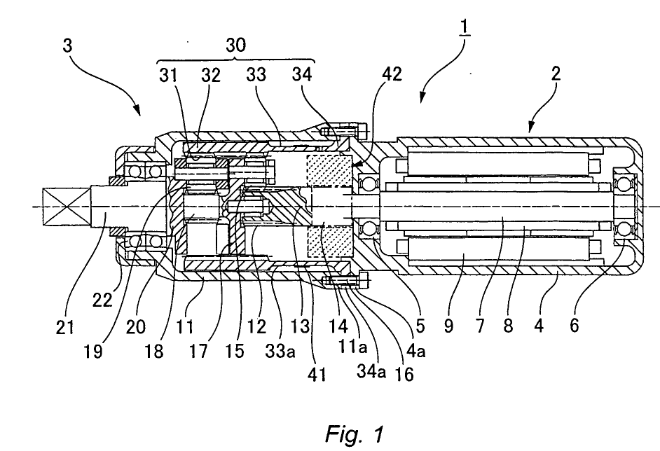

FIG. 1 is a schematic longitudinal sectional view of a rotation actuator in which the present invention has been applied. A rotation actuator 1 comprises a motor 2 and a planetary reduction gear device 3 (planetary gear apparatus) coaxially connected to the front end of the motor 2. The motor 2 has a cylindrical motor housing 4, a motor output shaft 7 rotatably supported by bearings 5 and 6 mounted on the front and rear end wall portions of the motor housing, a rotor 8 mounted on the motor output shaft 7, and a stator 9 mounted on the internal peripheral surface of the motor housing 4 so as to encompass the rotor 8 with a fixed gap. The motor output shaft 7 protrudes from the front surface of the motor housing 4 and is coaxially connected and fixed to the side of the planetary reduction gear device 3.

The planetary reduction gear device 3 is a two-stage planetary reduction gear device and has a cylindrical device housing 11, a front-stage sun gear 12, and an input shaft 13. The front-stage sun gear 12 is integrally formed with the front-stage sun gear 12 and is disposed at the center of the rear end side in the cylindrical device housing 11. The input shaft 13 is connected and fixed to the motor output shaft 7 via a coupling 14.

The front-stage sun gear 12 is meshed with a plurality of front-stage planetary gears 15. The front-stage planetary gears 15 mesh with an internal gear 30 that is a common internal gear for the front and rear stages. A front-stage carrier 17 that supports the front-stage planetary gears 15 is rotatably supported in a cantilevered state on the distal end portion of the input shaft 13, and a rear-stage sun gear 18 is coaxially and integrally formed on the front side surface of the carrier 17.

A plurality of rear-stage planetary gears 19 mesh with the rear-stage sun gear 18, and also mesh with the common internal gear 30. An output shaft 21 is coaxially and integrally formed on a rear-stage carrier 20 that supports the rear-stage planetary gears 19. The output shaft 21 is rotatably supported by a bearing 22 mounted on the distal end of the device housing 11. The output shaft 21 has the distal end portion that protrudes forward from the distal end of the device housing 11. The distal end portion of the shaft 21 is connected and fixed to a member (not shown) on the load side.

The internal gear 30 of the present example has an internal gear formation portion 32 on which internal teeth 31 are formed, a thin cylindrical portion 33 that coaxially and cylindrically extends from the read end (end on the motor side) of the internal gear formation portion 32, and a thick annular flange 34 formed on the rear end of the cylindrical portion 33. The annular flange 34 has a mounting flange 34a which widens to the outer side in the radial direction and is sandwiched between a rear end surface 11a of the device housing 11 and a mounting flange 4a formed on the external peripheral edge portion of the front end of the motor housing 4. In this sandwiched state, the motor housing 4 and device housing 11 are connected and fixed to each other by a plurality of fixing bolts 16.

The cylindrical portion 33 in the internal gear 30 of this configuration has a concave external peripheral surface portion 33a and is thinner than the internal gear formation portion 32 and annular flange 34 disposed on both side thereof. Strain gauges 41 for detecting strain produced by load torque are attached to the external peripheral surface portion 33a at fixed angular intervals along the circumferential direction. The load torque can be measured based on the detection signals of the strain gauges 41. Torque detection mechanisms with this configuration are known and further description is therefore omitted.

It is also possible to use as the torque detection mechanism a device in which a magnetic strip is formed on the cylindrical portion 33, and the load torque is measured by detecting magnetic strain produced by the load torque, instead of using a strain gauge for detecting the mechanical strain of the cylindrical portion 33 as resistance variation. In this case, a magnetic strip with a prescribed pattern may be formed on the external peripheral surface portion 33a of the cylindrical portion 33, or magnetic pieces (tapes) can be attached in prescribed patterns. The magnetic strain-type torque detection mechanism is also known.

Next, an angle detector 42 for detecting rotational information, e.g., the rotational angle of the input shaft 13 is disposed in the annular space on the inner side of the annular flange 34 and the cylindrical portion 33 of the internal gear 30. The angle detector 42 is an encoder, resolver, or the like.

With the rotation actuator 1 of the present example configured in this manner, a thin cylindrical portion 33 is formed on the internal gear 30 of the planetary reduction gear device 3, and strain produced by load torque generated in the cylindrical portion is detected and the load torque is measured by attaching a strain gauge 41 to the external peripheral surface portion 33a of the cylindrical portion. A position for disposing a strain gauge 41 can therefore be secured without the need to provide another member for torque detection.

The angle detector 42 is disposed by making use of the annular space formed on the inner side of the cylindrical portion 33, which is formed in order to attach the strain gauge 41. In other words, the angle detector 42 and a portion for attaching a strain gauge are concentrically disposed. As a result, the space for mounting an angle detector can be assured without increasing the axial length of the rotation actuator 1.

Accordingly, a rotation actuator 1 that has a short axial length and is provided with a torque detection mechanism and an angle detector can be obtained.

In the present example, the external peripheral surface portion 33a of the cylindrical portion 33 is used as the location for disposing or forming a strain gauge or another detection element for torque detection. The internal peripheral surface portion of the cylindrical portion 33 may be used in lieu thereof.

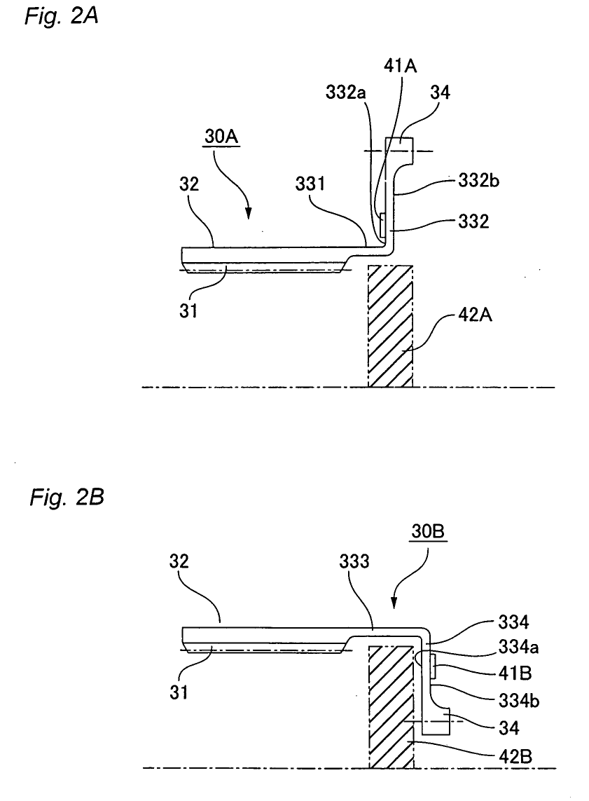

An internal gear 30A may have a shape in which a cylindrical portion 331 and an annular portion 332 that radially widens to the external side are disposed between the internal gear formation portion 32 on which internal teeth 31 are formed and a fixed portion 34 for fixing the internal gear 30A to the side of the housing or another fixed member, as shown in FIG. 2A. In this case, the annular portion 332 is made thin, and one or both of the two annular lateral surfaces 332a and 332b may be used as a location for disposing or forming a detection element 41A. Also, the space on the inner side of these surfaces may be used for disposing an angle detector or another rotational information detection mechanism 42A.

An internal gear 30B may have a shape in which a cylindrical portion 333 and an annular portion 334 that radially widens to the inner side are disposed between a fixed portion 34 and the internal gear formation portion 32 on which internal teeth 31 are formed, as shown in FIG. 2B. In this case, the annular portion 334 is made thin, and one or both of the two annular lateral surfaces 334a and 334b of the annular potion may be used as a location for disposing or forming a detection element 41B. Also, the space on the inner side of the cylindrical portion 333 may be used as a location for disposing an angle detector or another rotational information detection mechanism 42B.

What is claimed is:

1. A method for mounting a detection mechanism for a planetary gear apparatus, comprising:
forming a cylindrical portion between an internal gear formation portion and a portion fixed to other member in an internal gear of a planetary gear apparatus;
using an external peripheral surface or internal peripheral surface of the cylindrical portion as a location for disposing or forming a detection element for measuring a transmission torque transmitted via the internal gear; and
using an inner portion of the cylindrical portion as a mounting location of a rotational information detection mechanism for detecting rotational information of an input rotation element or output rotation element of the planetary gear apparatus.

2. A method for mounting a detection mechanism for a planetary gear apparatus, comprising:
forming, between an internal gear formation portion and a portion fixed to other member in an internal gear of a planetary gear apparatus, a cylindrical portion and an annular portion that widens from one end of the cylindrical portion to an external side in a radial direction;
using an annular lateral surface of the annular portion as a location for disposing or forming a detection element for measuring a transmission torque transmitted via the internal gear; and
using an inner portion of the cylindrical portion as a mounting location of a detection mechanism for detecting rotational information of an input rotation element or output rotation element of the planetary gear apparatus.

3. A planetary gear apparatus comprising:
a load torque detection device; and
a rotational information detection mechanism for detecting input rotational information or output rotational information, wherein
an internal gear of the planetary gear apparatus has an internal gear formation portion, a fixing portion for fixing the internal gear to other member, and a cylindrical portion formed between the internal gear formation portion and the fixing portion;
a detection element of the load torque detection mechanism is disposed or formed on an external peripheral surface or internal peripheral surface of the cylindrical portion; and
the rotational information detection mechanism is disposed inside the cylindrical portion.

4. A planetary gear apparatus comprising:
a load torque detection device; and
a rotational information detection mechanism for detecting input rotational information or output rotational information, wherein
an internal gear of the planetary gear apparatus has a an internal gear formation portion, a fixing portion for fixing the internal gear to other member, a cylindrical portion and an annular portion that widens from one end of the cylindrical portion to an external side in a radial direction, the cylindrical portion and the annular portion being formed between the internal gear formation portion and the fixing portion;
a detection element of the load torque detection mechanism is disposed or formed on an annular lateral surface of the annular portion; and
the rotational information detection mechanism is disposed inside the cylindrical portion.

5. A rotation actuator comprising:
a motor;
a planetary gear apparatus coaxially mounted on the motor;
a rotational information detection mechanism for detecting rotational information of an output shaft of the motor; and
a torque detection mechanism for detecting transmission torque transmitted via the planetary gear apparatus, wherein the planetary gear apparatus comprises:
a cylindrical device housing;
an internal gear fixed to the device housing;
an input shaft coaxially connected to the output shaft of the motor;
a sun gear formed on the input shaft; and
at least one planetary gear that meshes with the internal gear and the sun gear, wherein
the internal gear has an internal gear formation portion in which internal teeth that mesh with the planetary gear are formed, a cylindrical portion that coaxially extends from one end of the internal tooth formation portion, and an annular flange connected to an edge of the cylindrical portion, the annular flange being fixed to the device housing;
a detection element of the load torque detection mechanism is disposed or formed on an external peripheral surface or internal peripheral surface of the cylindrical portion; and
the rotational information detection mechanism mounted on the input shaft is mounted on an inner side of the cylindrical portion.
